(19) United States
(12) Patent Application Publication
(10) Pub. No.: US 2023/0319608 A1
(43) Pub. Date: Oct. 5, 2023

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP)

(73) Assignee: NTT DOCOMO, INC., Tokyo (JP)

(21) Appl. No.: 18/041,736

(22) PCT Filed: Aug. 17, 2020
(86) PCT No.: PCT/JP2020/030988

§ 371 Date: Feb. 15, 2023

(51) Int. Cl. H04W 24/08; H04L 5/00

(52) U.S. Cl. CPC H04W 24/08; H04L 5/0051

(57) ABSTRACT

A terminal according to an aspect of the present disclosure includes: a receiving section that receives a configuration of a plurality of channel state information-reference signal (CSI-RS) resources and receives a medium access control-control element (MAC CE) indicating one CSI-RS resource among the plurality of CSI-RS resources; and a control section that performs measurement of the CSI-RS resource and does not perform measurement of a CSI-RS resource other than the CSI-RS resource among the plurality of CSI-RS resources, in which the plurality of CSI-RS resources are individually associated with a plurality of quasi co-locations (QCLs). According to an aspect of the present disclosure, a P-CSI-RS resource can be efficiently used.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). In addition, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+ (plus), 6th generation mobile communication system (6G), New Radio (NR), or 3GPP Rel. 15 and subsequent releases) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In a future radio communication system (for example, NR), it has been studied that a user terminal (terminal, a user terminal, user equipment (UE)) controls transmission/reception processing on the basis of information regarding quasi-co-location (QCL).

However, when a large number of periodic channel state information-reference signals (P-CSI-RSs) are configured for management of a large number of beams, resource use efficiency may be lowered, and a reduction in throughput or the like may be caused.

Therefore, an object of the present disclosure is to provide a terminal, a radio communication method, and a base station that efficiently use a P-CSI-RS resource.

### Solution to Problem

A terminal according to an aspect of the present disclosure includes: a receiving section that receives a configuration of a plurality of channel state information-reference signal (CSI-RS) resources and receives a medium access control-control element (MAC CE) indicating one CSI-RS resource among the plurality of CSI-RS resources; and a control section that performs measurement of the CSI-RS resource and does not perform measurement of a CSI-RS resource other than the CSI-RS resource among the plurality of CSI-RS resources, in which the plurality of CSI-RS resources are individually associated with a plurality of quasi co-locations (QCLs).

### Advantageous Effects of Invention

According to an aspect of the present disclosure, a P-CSI-RS resource can be efficiently used.

### BRIEF DESCRIPTION OF DRAWINGS

FIGS. 1A and 1B are diagrams illustrating an example of MAC CE in option 1 of a first embodiment.

FIGS. 2A and 2B are diagrams illustrating an example of MAC CE in option 2 of the first embodiment.

FIG. 3 is a diagram illustrating an example of MAC CE in a modification of the first embodiment.

FIG. 4 is a diagram illustrating an example of MAC CE in another modification of the first embodiment.

FIGS. 5A and 5B are diagrams illustrating an example of MAC CE in option 1 of a second embodiment.

FIGS. 6A and 6B are diagrams illustrating an example of MAC CE in option 2 of the second embodiment.

FIGS. 7A to 7C are diagrams illustrating an example of MAC CE in options 3 to 5 of the second embodiment.

FIGS. 8A and 8B are diagrams illustrating an example of MAC CE in option 1 of a third embodiment.

FIGS. 9A and 9B are diagrams illustrating an example of MAC CE in option 2 of the third embodiment.

FIGS. 10A and 10B are diagrams illustrating an example of MAC CE in a modification of the third embodiment.

FIGS. 11A and 11B are diagrams illustrating an example of MAC CE in another modification of the third embodiment.

FIGS. 12A and 12B are diagrams illustrating examples of operations of a plurality of UEs.

FIGS. 13A and 13B are diagrams illustrating examples of scheduling restriction.

FIG. 14 is a diagram illustrating an example of switching of a P-CSI-RS resource in a sixth embodiment.

FIG. 15 is a diagram illustrating an example of activation of a CSI-RS resource in a list in a seventh embodiment.

FIG. 16 is a diagram illustrating an example of updating of a common beam in an eighth embodiment.

FIG. 17 is a diagram illustrating an example of a schematic configuration of a radio communication system according to one embodiment.

FIG. 18 is a diagram illustrating an example of a configuration of a base station according to one embodiment.

FIG. 19 is a diagram illustrating an example of a configuration of a user terminal according to one embodiment.

FIG. 20 is a diagram illustrating an example of a hardware configuration of the base station and the user terminal according to one embodiment.

### DESCRIPTION OF EMBODIMENTS

(TCI, Spatial Relation, and QCL)

In NR, it has been studied to control reception processing (for example, at least one of reception, demapping, demodulation, and decoding) and transmission processing (for example, at least one of transmission, mapping, precoding, modulation, and coding) in UE of at least one of a signal and a channel (expressed as a signal/channel) based on a transmission configuration indication state (TCI state).

The TCI state may represent what is applied to a downlink signal/channel. One corresponding to the TCI state applied to an uplink signal/channel may be expressed as a spatial relation.

The TCI state is information regarding a quasi-co-location (QCL) of the signal/channel, and may also be referred to as, for example, a spatial Rx parameter, spatial relation information, or the like. The TCI state may be configured in the UE for each channel or each signal.

The QCL is an indicator indicating a statistical property of a signal/channel. For example, when one signal/channel and another signal/channel have a QCL relation may mean that it is possible to assume that at least one of Doppler shift, Doppler spread, an average delay, a delay spread, and a spatial parameter (for example, a spatial Rx parameter) is identical (in QCL with respect to at least one of these) between the plurality of different signals/channels.

Note that the spatial Rx parameter may correspond to a reception beam of the UE (for example, a reception analog beam), and the beam may be specified based on spatial QCL. The QCL (or at least one element of the QCL) in the present disclosure may be replaced with spatial QCL (sQCL).

A plurality of types of QCL (QCL types) may be defined. For example, four QCL types A to D with different parameters (or parameter sets) that can be assumed to be identical may be provided. These parameters (which may be referred to as QCL parameters) are as follows:
QCL type A (QCL-A): Doppler shift, Doppler spread, average delay, and delay spread;
QCL type B (QCL-B): Doppler shift and Doppler spread;
QCL type C (QCL-C): Doppler shift and average delay; and
QCL type D (QCL-D): spatial Rx parameter.

It may be referred to as a QCL assumption for the UE to assume that a certain control resource set (CORESET), channel, or reference signal has a specific QCL (for example, QCL type D) relation with another CORESET, channel, or reference signal.

The UE may determine at least one of a transmission beam (Tx beam) and a reception beam (Rx beam) of a signal/channel based on a TCI state of the signal/channel or the QCL assumption.

The TCI state may be, for example, information regarding the QCL of a target channel (in other words, a reference signal (RS) for the channel) and another signal (for example, another RS). The TCI state may be configured (given in instruction) by higher layer signaling, physical layer signaling, or a combination thereof.

The physical layer signaling may be, for example, Downlink Control Information (DCI).

A channel for which a TCI state or spatial relation is configured (specified) may be, for example, at least one of a Physical Downlink Shared Channel (PDSCH), a Physical Downlink Control Channel (PDCCH), a Physical Uplink Shared Channel (PUSCH), and a Physical Uplink Control Channel (PUCCH).

Furthermore, an RS having a QCL relation with the channel may be, for example, at least one of a Synchronization Signal Block (SSB), a Channel State Information Reference Signal (CSI-RS)), a measurement reference signal (Sounding Reference Signal (SRS)), a tracking CSI-RS (also referred to as a Tracking Reference Signal (TRS)), and a QCL detection reference signal (also referred to as a QRS).

The SSB is a signal block including at least one of a primary synchronization signal (PSS), a secondary synchronization signal (SSS), and a broadcast channel (physical broadcast channel (PBCH)). The SSB may be referred to as an SS/PBCH block.

An RS of QCL type X in a TCI state may mean an RS in a QCL type X relation with (DMRS of) a certain channel/signal, and this RS may be referred to as a QCL source of QCL type X in the TCI state.

(Path-loss RS) The Path-loss PL_{b,f,c} (q_{d}) [dB] in transmission power control of each of a PUSCH, a PUCCH, and an SRS is calculated by the UE by using the index q_{d} of a reference signal (an RS, or a Path-loss reference RS (PathlossReferenceRS)) for a downlink BWP associated with the active UL BWP b of the carrier f of the serving cell c. In the present disclosure, the Path-loss reference RS, the Path-loss (PL)-RS, the index q_{d}, the RS used for Path-loss calculation, and an RS resource used for Path-loss calculation may be replaced with each other. In the present disclosure, calculation, estimation, measurement, and tracking may be replaced with each other.

Studies are being made on whether to change the existing mechanism of higher layer filtered RSRP for Path-loss measurement when the Path-loss RS is updated by an MAC CE.

When the Path-loss RS is updated by an MAC CE, Path-loss measurement based on L1-RSRP may be applied. At available timing after the MAC CE for updating the Path-loss RS, higher layer filtered RSRP may be used for Path-loss measurement; before the higher layer filtered RSRP is applied, L1-RSRP may be used for Path-loss measurement. At available timing after the MAC CE for updating the Path-loss RS, higher layer filtered RSRP may be used for Path-loss measurement; before the above-mentioned timing, the higher layer filtered RSRP of the previous Path-loss RS may be used. Similar to the operation of Rel. 15, higher layer filtered RSRP may be used for Path-loss measurement, and the UE may track all Path-loss RS candidates configured by the RRC. The maximum number of Path-loss RSs that can be configured by the RRC may depend on the UE capability. When the maximum number of Path-loss RSs that can be configured by the RRC is X, X or less Path-loss RS candidates may be configured by the RRC, and a Path-loss RS may be selected by the MAC CE from among the configured Path-loss RS candidates. The maximum number of Path-loss RSs that can be configured by RRC may be 4, 8, 16, 64, or the like.

In the present disclosure, higher layer filtered RSRP, filtered RSRP, and layer 3 filtered RSRP may be replaced with each other.

(Default TCI State/Default Spatial Relation/Default PL-RS)

In an RRC connection mode, both in a case where in-DCI TCI information (higher layer parameter TCI-PresentInDCI) is set to “enabled” and in a case where no in-DCI TCI information is configured, if the time offset between the reception of DL DCI (DCI that schedules a PDSCH) and the corresponding PDSCH (the PDSCH scheduled by the DCI) is smaller than a threshold (timeDurationForQCL) (application condition: a first condition), in the case of non-cross-carrier scheduling, the TCI state (a default TCI state) of the PDSCH may be the TCI state of the lowest CORESET ID in the newest slot in an active DL BWP of the CC (of a specific UL signal). Otherwise, the TCI state (a default TCI state) of a PDSCH may be the TCI state of the lowest TCI state ID of PDSCHs in an active DL BWP of a CC where scheduling is made.

In Rel. 15, individual MAC CEs of an MAC CE for activation/deactivation of a PUCCH spatial relation and an MAC CE for activation/deactivation of an SRS spatial relation are needed. The PUSCH spatial relation conforms to the SRS spatial relation.

In Rel. 16, at least one of an MAC CE for activation/deactivation of a PUCCH spatial relation and an MAC CE for activation/deactivation of an SRS spatial relation may not be used.

When, in FR2, neither a spatial relation nor a PL-RS for a PUCCH is configured (application condition: a second condition), default assumptions of the spatial relation and the PL-RS (a default spatial relation and a default PL-RS) are applied to the PUCCH. When, in FR2, neither a spatial relation nor a PL-RS for an SRS (an SRS resource for an SRS, or an SRS resource corresponding to an SRI in DCI format 0_1 that schedules a PUSCH) is configured (application condition: the second condition), default assumptions of the spatial relation and the PL-RS (a default spatial relation and a default PL-RS) are applied to the PUSCH scheduled by DCI format 0_1 and the SRS.

When CORESETs are configured in an active DL BWP on the CC, the default spatial relation and the default PL-RS may be the TCI state or the QCL assumption of the CORESET having the lowest CORESET ID in the active DL BWP. When no CORESETs are configured in an active DL BWP on the CC, the default spatial relation and the default PL-RS may be the active TCI state having the lowest ID of PDSCHs in the active DL BWP.

In Rel. 15, the spatial relation of a PUSCH scheduled by DCI format 0_0 conforms to the spatial relation of the PUCCH resource having the lowest PUCCH resource ID among active spatial relations of PUCCHs on the same CC. Even when no PUCCHs are transmitted on SCells, the network needs to update the PUCCH spatial relations on all SCells.

In Rel. 16, a PUCCH configuration for a PUSCH scheduled by DCI format 0_0 is not needed. When, for a PUSCH scheduled by DCI format 0_0, there is no active PUCCH spatial relation or no PUCCH resource on an active UL BWP in the CC (application condition: the second condition), a default spatial relation and a default PL-RS are applied to the PUSCH.

The condition under which a default spatial relation/default PL-RS for SRS is applied may include that a default beam path-loss enabling information element for SRS (a higher layer parameter enableDefaultBeamPlForSRS) be effectively set. The condition under which a default spatial relation/default PL-RS for PUCCH is applied may include that a default beam path-loss enabling information element for PUCCH (a higher layer parameter enableDefaultBeamPlForPUCCH) be effectively set. The condition under which a default spatial relation/default PL-RS for PUSCH scheduled by DCI format 0_0 is applied may include that a default beam path-loss enabling information element for PUSCH scheduled by DCI format 0_0 (a higher layer parameter enableDefaultBeamPlForPUSCH0_0) be effectively set.

Further, the above-mentioned threshold may be referred to as QCL time duration “timeDurationForQCL”, “threshold”, “threshold for offset between a DCI indicating a TCI state and PDSCH scheduled by the DCI”, “threshold-Sched-Offset”, a schedule offset threshold, a scheduling offset threshold, or the like.

(CSI)

In NR, a UE measures a channel state by using a reference signal (or a resource for the reference signal) and feeds back (reports) channel state information (CSI) to a network (for example, a base station).

The UE may measure the channel state using at least one of a channel state information reference signal (CSI-RS), a synchronization signal/physical broadcast channel (SS/PBCH) block, a synchronization signal (SS), a demodulation reference signal (DMRS), and the like.

A CSI-RS resource may include at least one of a Non Zero Power (NZP) CSI-RS resource, a Zero Power (ZP) CSI-RS resource, and a CSI Interference Measurement (CSI-IM) resource.

A resource for measuring a signal component for CSI may be referred to as a signal measurement resource (SM) or a channel measurement resource (CMR). The SMR (CMR) may include, for example, an NZP CSI-RS resource for channel measurement, an SSB, and the like.

A resource for measuring an interference component for CSI may be referred to as an Interference Measurement Resource (IMR). The IMR may include, for example, at least one of the NZP CSI-RS resource for interference measurement, an SSB, a ZP CSI-RS resource, and a CSI-IM resource.

The SS/PBCH block is a block including a synchronization signal (e.g., primary synchronization signal (PSS) and secondary synchronization signal (SSS)) and a PBCH (and the corresponding DMRS), which may be called an SS block (SSB) or the like.

Note that, the CSI may include at least one of a Channel Quality Indicator (CQI), a Precoding Matrix Indicator (PMI), a CSI-RS Resource Indicator (CRI), an SS/PBCH Block Resource Indicator (SSBRI), a Layer Indicator (LI), a Rank Indicator (RI), Layer 1 Reference Signal Received Power (L1-RSRP), L1-Reference Signal Received Quality (RSRQ), an L1-Signal to Interference Plus Noise Ratio (SINR), an L1-Signal to Noise Ratio (SNR), and the like.

The CSI may include a plurality of parts. A CSI part 1 may include information with a relatively small number of bits (for example, the RI). A CSI part 2 may include information with a relatively large number of bits (for example, the CQI) such as information determined on the basis of the CSI part 1.

Furthermore, the CSI may also be classified into several CSI types. The type and size of information to be reported may be different depending on the CSI type. For example, a CSI type configured for performing communication using a single beam (also referred to as type 1 (type I) CSI, CSI for a single beam, or the like), and a CSI type configured for performing communication using multiple beams (also referred to as type 2 (type II) CSI, CSI for multiple beams, or the like) may be specified. The usage of the CSI type is not limited to those.

As a CSI feedback method, periodic CSI (periodic CSI (P-CSI)) report, aperiodic CSI (Aperiodic CSI (A-CSI, AP-CSI)) report, semi-persistent CSI (semi-persistent CSI (SP-CSI)) report, and the like have been studied.

The UE may be notified of CSI measurement configuration information using higher layer signaling, physical layer signaling, or a combination thereof.

In the present disclosure, the higher layer signaling may be any of, for example, radio resource control (RRC) signaling, medium access control (MAC) signaling, broadcast information, and the like, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), other system information (OSI), or the like.

The physical layer signaling may be, for example, Downlink Control Information (DCI).

The CSI measurement configuration information may be configured using, for example, the RRC information element “CSI-MeasConfig”. The CSI measurement configuration information may include CSI resource configuration information (RRC information element “CSI-ResourceConfig”), CSI report configuration information (RRC information element “CSI-ReportConfig”), and the like. The CSI resource configuration information is related to a resource for CSI measurement, and the CSI reporting configuration information is related to how the UE performs CSI reporting.

The RRC information element (or the RRC parameter) concerning the CSI report setting and the CSI resource setting is explained.

The CSI reporting configuration information (“CSI-ReportConfig”) includes channel measurement resource information (“resourcesForChannelMeasurement”). Furthermore, the CSI report configuration information may include resource information for interference measurement (for example, NZP CSI-RS resource information for interference measurement (“nzp-CSI-RS-ResourcesForinterference”), CSI-IM resource information for interference measurement (“csi-IM-ResourcesForinterference”), and the like. These pieces of resource information correspond to CSI resource configuration information IDs (Identifiers) (“CSI-ResourceConfigId”).

Note that, the CSI resource configuration information IDs (which may be referred to as CSI resource configuration IDs) corresponding to respective pieces of resource information may have the same value in one or more IDs or may respectively have different values.

The CSI resource setting information (“CSI-ResourceConfig”) may include a CSI resource setting information ID, CSI-RS resource set list information (“csi-RS-ResourceSetList”), a resource type (“resourceType”), and the like. The CSI-RS resource set list may include at least one of NZP CSI-RS and SSB information (“nzp-CSI-RS-SSB”) for measurement and CSI-IM resource set list information (“csi-IM-Resource Set List”).

The resource type represents a behavior of a time domain of this resource setting, and “aperiodic”, “semi-persistent”, and “periodic” can be set. For example, the corresponding CSI-RS may be referred to as A-CSI-RS (AP-CSI-RS), SP-CSI-RS, or P-CSI-RS.

Note that, a resource for channel measurement may be used for calculation of, for example, the CQI, PMI, L1-RSRP, and the like. Furthermore, a resource for interference measurement may be used for calculation of the L1-SINR, L1-SNR, L1-RSRQ, and other indicators regarding interference.

(Simultaneous Beam Update of Plurality of CCs)

In Rel. 16, one MAC CE can update beam indexes (TCI states) of a plurality of CCs.

The UE may have up to two applicable CC lists (for example, applicable-CC-lists) configured by RRC. When the two applicable CC lists are configured, the two applicable CC lists may respectively correspond to intra-band CA in FR1 and intra-band CA in FR2.

The activation MAC CE of the TCI state of the PDCCH activates the TCI state associated with the same CORESET ID on all BWPs/CCs in the applicable CC list.

The activation MAC CE of the TCI state of the PDSCH activates the TCI state on all the BWPs/CCs in the applicable CC list.

The activation MAC CE of a spatial relation of A-SRS/SP-SRS activates the spatial relation associated with the same SRS resource ID on all BWPs/CCs in the applicable CC list.

(Beam Management)

In DL/UL beam management, an attempt to achieve more efficient beam management such as lower latency or lower overhead is being studied.

A QCL assumption/TCI state of a periodic CSI-RS (P-CSI-RS) (for example, an information element qcl-InfoPeriodicCSI-RS(TCI-StateId)) is configured via RRC signaling (for example, an information element NZP-CSI-RS-Resource). The existing P-CSI-RS continues to be transmitted by using a configured TCI state.

To optimize the management of all beams, a scheme in which a large number of P-CSI-RSs are configured is conceivable. If a small number of P-CSI-RSs are configured, RRC reconfiguration of a QCL assumption/TCI state of a P-CSI-RS is needed to support the management of a large number of beams, which is not efficient.

If a large number of P-CSI-RSs are configured for optimal beam management, after beam management, a large number of P-CSI-RSs are not needed, and a small number of P-CSI-RSs are needed for the UE. In this case, frequent RRC reconfiguration for changing a CSI-RS is needed, which is not efficient.

Thus, the present inventors have conceived a method of appropriately changing a P-CSI-RS used.

Hereinafter, embodiments according to the present disclosure will be described in detail with reference to the drawings. The configurations described in each of the aspects may be applied singly or in combination.

In the present disclosure, “A/B” and “at least one of A or B” may be interchangeable. In the present disclosure, the cell, the CC, the carrier, the BWP, the DL BWP, the UL BWP, the active DL BWP, the active UL BWP, and the band may be replaced with each other. In the present disclosure, an index, an ID, an indicator, and a resource ID may be read as interchangeable with each other. In the present disclosure, an RRC parameter, a higher layer parameter, an RRC information element (IE), and an RRC message may be read as interchangeable with each other. In the present disclosure, “support”, “control”, “control”, “operate”, and “operable” may be replaced with each other.

In the present disclosure, “activate”, “update”, “indicate”, “enable”, and “specify” may be replaced with each other.

In the present disclosure, the MAC CE and the activation/deactivation command may be replaced with each other.

In the present disclosure, the higher layer signaling may be any of, for example, radio resource control (RRC) signaling, medium access control (MAC) signaling, broadcast information, and the like, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), other system information (OSI), or the like.

In the present disclosure, the beam, the spatial domain filter, the TCI state, the UL-TCI state, the QCL assumption, the QCL parameter, the spatial domain reception filter, the UE spatial domain reception filter, the UE reception beam, the DL beam, the DL reception beam, the DL precoding, the DL precoder, the DL-RS, the QCL type D of the TCI state, the RS of the QCL type D of the TCI state, the RS of the QCL type D of the TCI state or the QCL assumption, the RS of the QCL type A of the TCI state or the QCL assumption, the spatial relation, the spatial domain transmission filter, the UE spatial domain transmission filter, the UE Tx beam, the UL beam, the UL Tx beam, the UL precoding, and the UL precoder may be replaced with each other. In the present disclosure, the QCL type X-RS, the DL-RS associated with QCL type X, the DL-RS with QCL type X, a source of the DL-RS, the SSB, and the CSI-RS may be replaced with each other.

In the present disclosure, the CC list, the cell list, the applicable list, the simultaneous TCI update list, the simultaneousTCI-UpdateList-r16/simultaneousTCI-UpdateListSecond-r16, the simultaneous TCI cell list, the simultaneousTCI-CellList, the simultaneous spatial update list, the simultaneousSpatial-UpdateList-r16/simultaneousSpatial-UpdateListSecond-r16, the simultaneousSpatial-UpdatedList-r16/simultaneousSpatial-UpdatedListSecond-r16, the configured CC, the configured list, the BWP/CC in the configured list, all the BWPs/CCs in the configured list, the CC indicated by the activation command, the indicated CC, the CC that has received the MAC CE, and the information indicating the plurality of cells for updating at least one of the TCI state and the spatial relation may be replaced with each other.

In the present disclosure, a P-CSI-RS, a CSI-RS, an NZP-CSI-RS, and a P-TRS may be replaced with each other. In the present disclosure, a CSI-RS resource, a CSI-RS resource set, a CSI-RS resource group, and an information element (IE) may be replaced with each other.

(Radio Communication Method)

### First Embodiment

The UE may support a scheme in which a TCI state/QCL assumption of a P-CSI-RS is updated by a new MAC CE.

A MAC CE may include one TCI state for a CSI-RS resource ID of one P-CSI-RS (non-zero power (NZP)-CSI-RS), alternatively for a CSI-RS resource ID of a plurality of P-CSI-RSs (NZP-CSI-RSs), alternatively for a CSI-RS resource set ID (CSI-RS resource group ID) of one P-CSI-RS (NZP-CSI-RS), or for a CSI-RS resource set ID (CSI-RS resource group ID) of a plurality of P-CSI-RSs (NZP-CSI-RSs).

The MAC CE may conform to either one of options 1 and 2 below.

<<Option 1>>

TCI state updating is performed for each CSI-RS resource ID of P-CSI-RS.

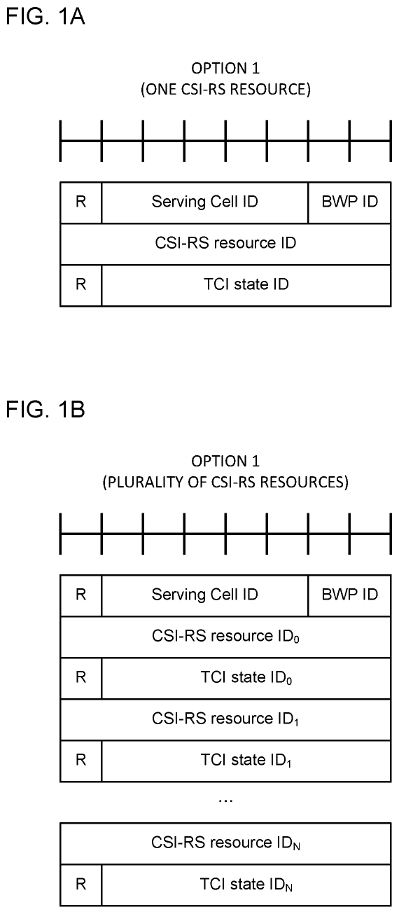

In the example of FIG. 1A, a MAC CE includes at least one of a reserved bit (R) field, one serving cell ID field, one bandwidth part (BWP) ID field, one P-CSI-RS resource ID field, and one TCI state ID field. The TCI state of a P-CSI-RS resource indicated by a P-CSI-RS resource ID is indicated by the TCI state ID field.

In the example of FIG. 1B, a MAC CE includes at least one of an R field, one serving cell ID field, one BWP ID field, N+1 P-CSI-RS resource ID (CSI-RS resource IDs 0 to N) fields, and N+1 TCI state ID (TCI state IDs 0 to N) fields. The N+1 TCI state ID fields individually correspond to the N+1 P-CSI-RS resource ID fields. The TCI state of each P-CSI-RS resource is indicated by the corresponding TCI state ID field.

<<Option 2>>

TCI state updating is performed for each CSI-RS resource set ID (CSI-RS resource group ID) of P-CSI-RS.

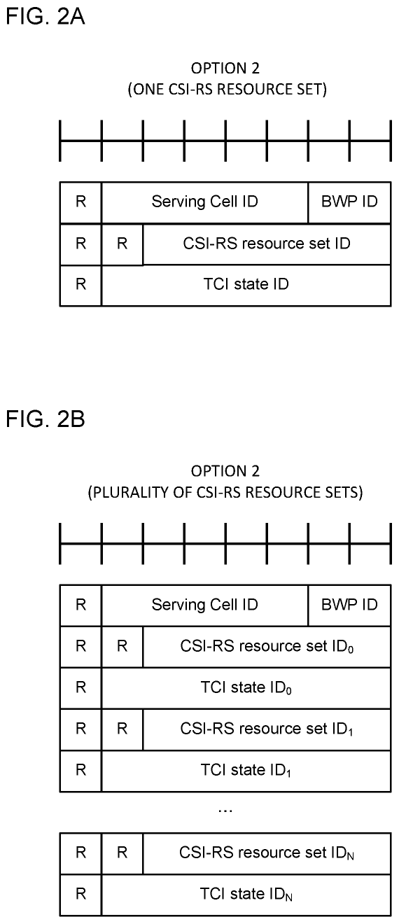

In the example of FIG. 2A, a MAC CE includes at least one of an R field, one serving cell ID field, one BWP ID field, one P-CSI-RS resource set ID field, and one TCI state ID field. The TCI state of a P-CSI-RS resource set indicated by a P-CSI-RS resource set ID is indicated by the TCI state ID field.

In the example of FIG. 2B, a MAC CE includes at least one of an R field, one serving cell ID field, one BWP ID field, N+1 P-CSI-RS resource set ID (CSI-RS resource set IDs 0 to N) fields, and N+1 TCI state ID (TCI state IDs 0 to N) fields. The N+1 TCI state ID fields individually correspond to the N+1 P-CSI-RS resource set ID fields. The TCI state of each P-CSI-RS resource set is indicated by the corresponding TCI state ID field.

<<Modification>>

A MAC CE may include one or a plurality of P-CSI-RS resource set IDs and a TCI state for each P-CSI-RS resource in the resource set.

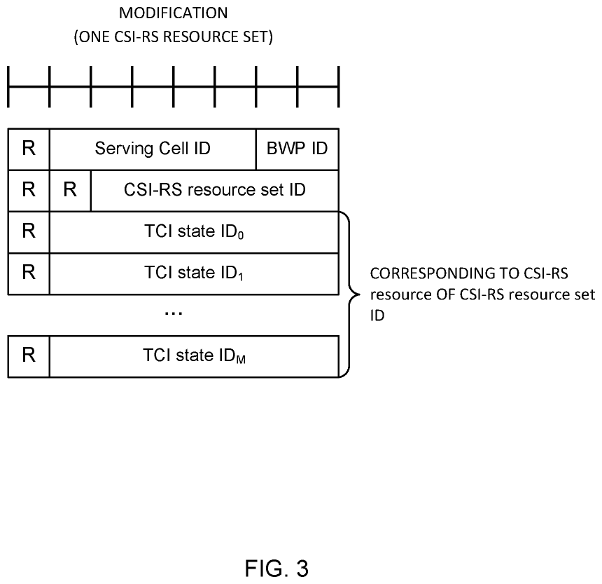

In the example of FIG. 3, a MAC CE includes at least one of an R field, one serving cell ID field, one BWP ID field, one P-CSI-RS resource set ID field, and M+1 TCI state ID (TCI state IDs 0 to M) fields. M+1 P-CSI-RS resources in a P-CSI-RS resource set indicated by a P-CSI-RS resource set ID correspond to the M+1 TCI state ID fields. The TCI state of each P-CSI-RS resource is indicated by the corresponding TCI state ID field.

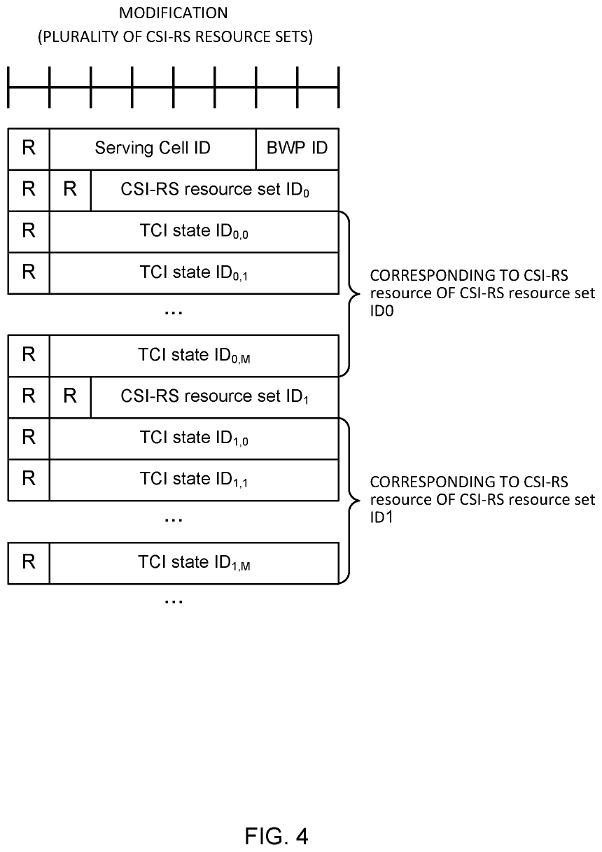

In the example of FIG. 4, a MAC CE includes at least one of an R field, one serving cell ID field, one BWP ID field, N+1 P-CSI-RS resource set ID (CSI-RS resource set IDs 0 to N) fields, and M+1 TCI state ID (TCI states IDs 0 to M) fields per P-CSI-RS resource set ID field. M+1 P-CSI-RS resources in a P-CSI-RS resource set indicated by each P-CSI-RS resource set ID correspond to consecutive M+1 TCI state ID fields. The TCI state of each P-CSI-RS resource is indicated by the corresponding TCI state ID field.

According to the first embodiment described above, the TCI state of a P-CSI-RS can be changed without performing RRC reconfiguration, and a large number of P-CSI-RS resources can be efficiently used.

### Second Embodiment

The UE may support a scheme in which a P-CSI-RS is activated/deactivated via a new MAC CE.

A MAC CE may include activation/deactivation for one P-CSI-RS resource, alternatively for one P-CSI-RS resource set, alternatively for a plurality of P-CSI-RS resources, or for a plurality of P-CSI-RS resource sets. For a plurality of P-CSI-RS resources/P-CSI-RS resource sets, the MAC CE may explicitly indicate P-CSI-RS resource IDs/P-CSI-RS resource set IDs, or may indicate P-CSI-RS resource IDs/P-CSI-RS resource set IDs by means of a bitmap.

The TCI state for a P-CSI-RS resource (for example, an information element qc1-InfoPeriodicCSI-RS(TCI-StateId)) may be configured by RRC signaling (for example, an information element NZP-CSI-RS-Resource). The MAC CE in the second embodiment may not include a TCI state ID field. A TCI state configured by an RRC parameter may be used for transmission of a P-CSI-RS.

The MAC CE may follow one of the following options 1 and 5.

<<Option 1>>

Activation/deactivation is performed on one or a plurality of P-CSI-RS resources for each CSI-RS resource ID.

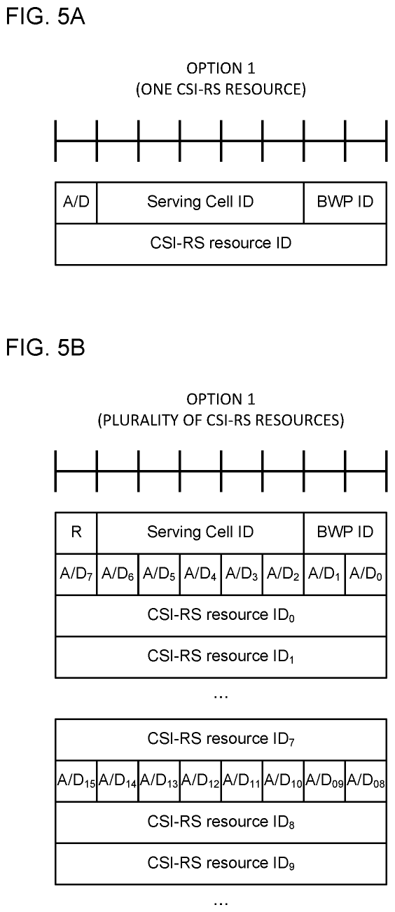

In the example of FIG. 5A, a MAC CE includes at least one of one activation/deactivation (A/D) field, one serving cell ID field, one BWP ID field, and one P-CSI-RS resource ID field. The activation or deactivation of a P-CSI-RS resource indicated by a P-CSI-RS resource ID is indicated by the A/D field.

In the example of FIG. 5B, a MAC CE includes at least one of an R field, one serving cell ID field, one BWP ID field, N+1 A/D fields, and N+1 P-CSI-RS resource ID fields. The N+1 A/D fields individually correspond to the N+1 P-CSI-RS resource ID fields. The activation or deactivation of each P-CSI-RS resource is indicated by the corresponding A/D field.

<<Option 2>>

Activation/deactivation is performed on one or a plurality of P-CSI-RS resource sets or P-CSI-RS resource groups for each P-CSI-RS resource set ID or each P-CSI-RS resource group ID.

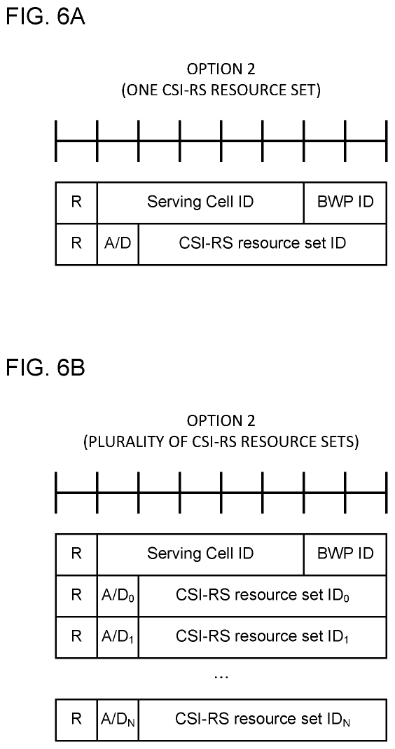

In the example of FIG. 6A, a MAC CE includes one activation/deactivation (A/D) field, one serving cell ID field, one BWP ID field, and one P-CSI-RS resource set ID field. The activation or deactivation of a P-CSI-RS resource set indicated by a P-CSI-RS resource set ID is indicated by the A/D field.

In the example of FIG. 6B, a MAC CE includes at least one of an R field, one serving cell ID field, one BWP ID field, N+1 A/D fields, and N+1 P-CSI-RS resource set ID fields. The N+1 A/D fields individually correspond to the N+1 P-CSI-RS resource set ID fields. The activation or deactivation of each P-CSI-RS resource set is indicated by the corresponding A/D field.

<<Option 3>>

The same activation/deactivation is performed on a plurality of P-CSI-RS resources.

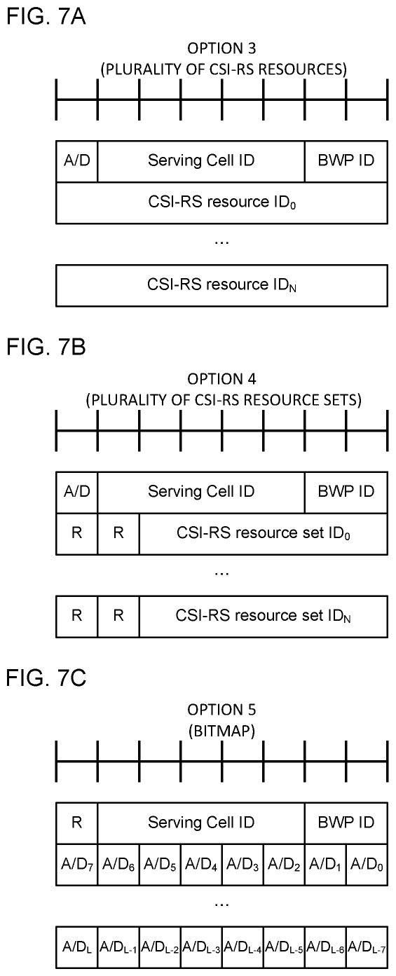

In the example of FIG. 7A, a MAC CE includes at least one of one A/D field, one serving cell ID field, one BWP ID field, and N+1 P-CSI-RS resource ID fields. The activation or deactivation of N+1 P-CSI-RS resources is indicated by the one A/D field.

<<Option 4>>

The same activation/deactivation is performed on a plurality of P-CSI-RS resource sets.

In the example of FIG. 7B, a MAC CE includes at least one of one A/D field, one serving cell ID field, one BWP ID field, an R field, and N+1 P-CSI-RS resource set ID fields. The activation or deactivation of N+1 P-CSI-RS resource sets is indicated by the one A/D field.

<<Option 5>>

A MAC CE indicates activation/deactivation for each P-CSI-RS resource or each P-CSI-RS resource set by means of a bitmap.

In the example of FIG. 7C, a MAC CE includes at least one of an R field, one serving cell ID field, one BWP ID field, and a bitmap. The bitmap includes L A/D fields.

The bitmap may follow one of the following options 5A and 5B.

<Option 5A>

The bitmap length L may be the maximum number of P-CSI-RS resources. Each A/D field may indicate the activation/deactivation of the corresponding P-CSI-RS resource.

<Option 5B>

The bitmap length L may be the maximum number of P-CSI-RS resource sets or P-CSI-RS resource groups. Each A/D field may indicate the activation/deactivation of the corresponding P-CSI-RS resource set or the corresponding P-CSI-RS resource group.

According to the second embodiment described above, a P-CSI-RS can be activated/deactivated without performing RRC reconfiguration, and a large number of P-CSI-RS resources can be efficiently used.

### Third Embodiment

The first embodiment and the second embodiment may be combined.

A new MAC CE for P-CSI-RS may conform to either one of options 1 and 2 below.

<<Option 1>>

A MAC CE may activate a P-CSI-RS resource or a P-CSI-RS resource set having a TCI state to be updated.

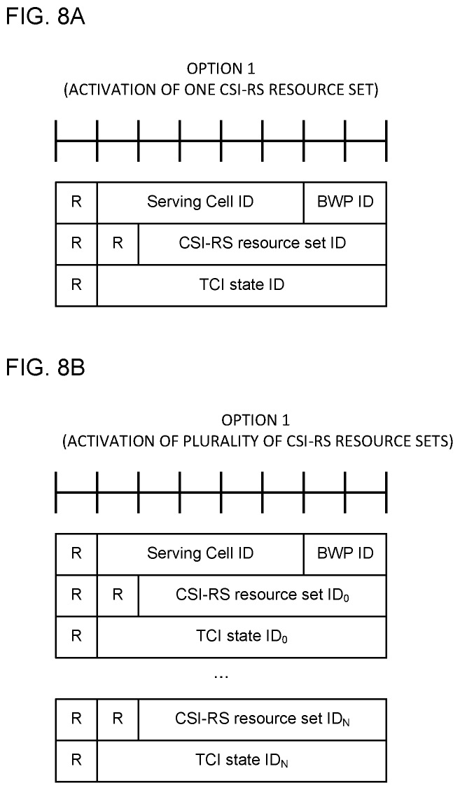

In the example of FIG. 8A, a MAC CE includes at least one of an R field, a serving cell ID field, a BWP ID field, one P-CSI-RS resource set ID field, and one TCI state ID field. The TCI state ID field indicates a TCI state corresponding to a P-CSI-RS resource indicated by the P-CSI-RS resource set ID field.

In the example of FIG. 8B, a MAC CE includes at least one of an R field, a serving cell ID field, a BWP ID field, N+1 P-CSI-RS resource set ID fields, and N+1 TCI state ID fields. The N+1 TCI state ID fields individually correspond to the N+1 P-CSI-RS resource set ID fields.

<<Option 2>>

A MAC CE may activate a P-CSI-RS resource or a P-CSI-RS resource set having a TCI state to be updated. The MAC CE may deactivate a P-CSI-RS resource or a P-CSI-RS resource set. The MAC CE for deactivation may not include a TCI state ID.

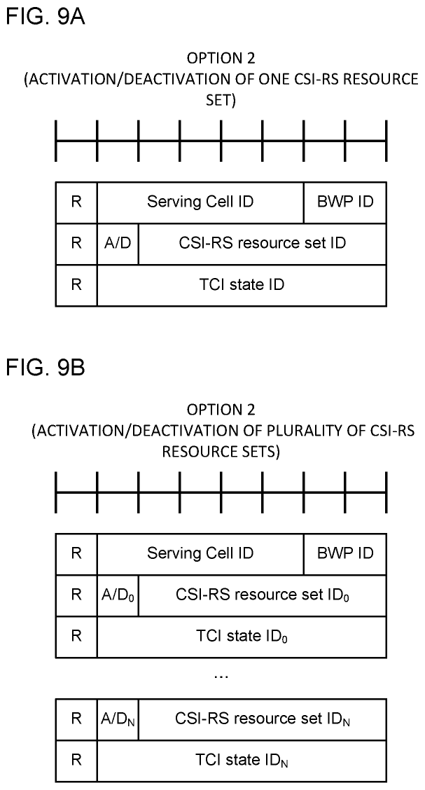

In the example of FIG. 9A, a MAC CE includes at least one of an R field, a serving cell ID field, a BWP ID field, one A/D field, one P-CSI-RS resource set ID field, and one TCI state field. In a case where the value of the A/D field is 1, a P-CSI-RS resource set indicated by the P-CSI-RS resource set ID field may be activated, and a TCI state field may exist. In a case where the value of the A/D field is 0, a P-CSI-RS resource set indicated by the P-CSI-RS resource set ID field may be deactivated, and a TCI state field may not exist.

In the example of FIG. 9B, a MAC CE includes at least one of an R field, a serving cell ID field, a BWP ID field, N+1 A/D fields, N+1 P-CSI-RS resource set ID fields, and N+1 TCI state ID fields. The N+1 A/D fields individually correspond to the N+1 P-CSI-RS resource set ID fields. The N+1 TCI state ID fields individually correspond to the N+1 P-CSI-RS resource set ID fields. In a case where the value of the A/D field is 1, a P-CSI-RS resource set indicated by the corresponding P-CSI-RS resource set ID field may be activated, and a corresponding TCI state field may exist. In a case where the value of the A/D field is 0, a P-CSI-RS resource set indicated by the corresponding P-CSI-RS resource set ID field may be deactivated, and a corresponding TCI state field may not exist.

<<Modification>>

A MAC CE may include one or a plurality of P-CSI-RS resource set IDs and a TCI state for each P-CSI-RS resource in the resource set.

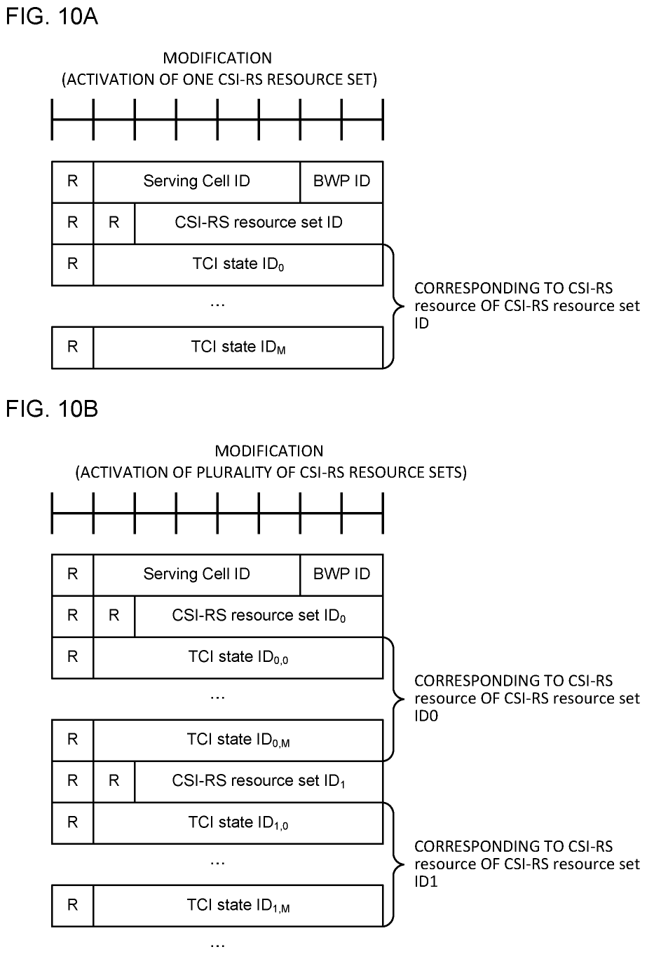

In the example of FIG. 10A, a MAC CE includes at least one of an R field, a serving cell ID field, a BWP ID field, one P-CSI-RS resource set ID field, and M+1 TCI state fields. A P-CSI-RS resource set indicated by one P-CSI-RS resource set ID field includes M+1 P-CSI-RS resources. The M+1 TCI state fields individually correspond to the M+1 P-CSI-RS resources.

In the example of FIG. 10B, a MAC CE includes at least one of an R field, a serving cell ID field, a BWP ID field, N+1 P-CSI-RS resource set ID fields, and M+1 TCI state fields per P-CSI-RS resource set ID field. A P-CSI-RS resource set indicated by one P-CSI-RS resource set ID field includes M+1 P-CSI-RS resources. The M+1 TCI state fields corresponding to one P-CSI-RS resource set individually correspond to the M+1 P-CSI-RS resources in the P-CSI-RS resource set.

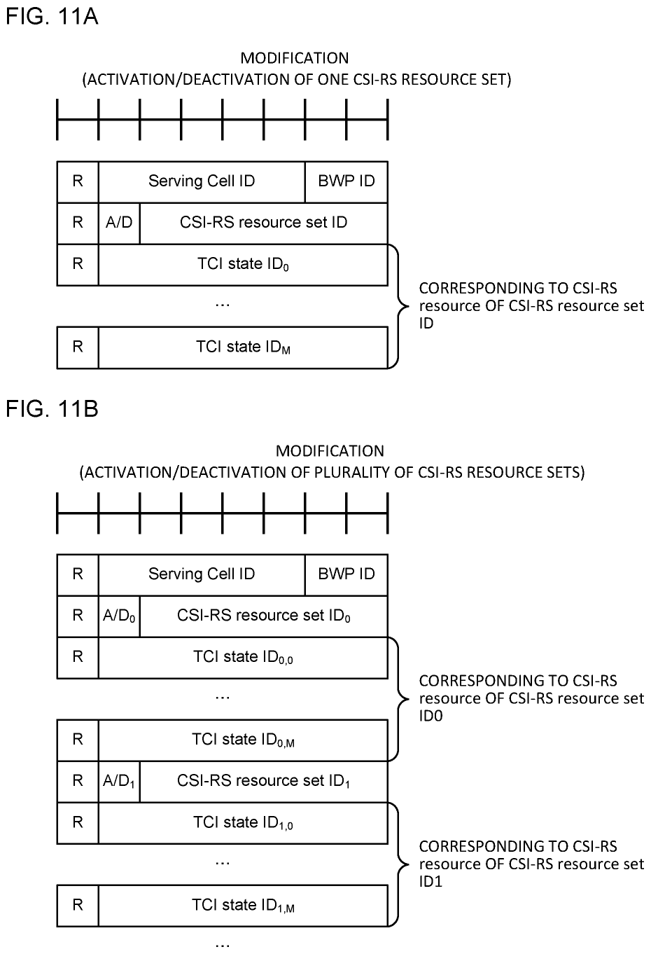

In the example of FIG. 11A, a MAC CE includes at least one of an R field, a serving cell ID field, a BWP ID field, one A/D field, one P-CSI-RS resource set ID field, and M+1 TCI state fields. A P-CSI-RS resource set indicated by one P-CSI-RS resource set ID field includes M+1 P-CSI-RS resources. The M+1 TCI state fields individually correspond to the M+1 P-CSI-RS resources. In a case where the value of the A/D field is 1, a P-CSI-RS resource set indicated by the P-CSI-RS resource set ID field may be activated, and M+1 TCI state fields may exist. In a case where the value of the A/D field is 0, a P-CSI-RS resource set indicated by the P-CSI-RS resource set ID field may be deactivated, and M+1 TCI state fields may not exist.

In the example of FIG. 11B, a MAC CE includes at least one of an R field, a serving cell ID field, a BWP ID field, N+1 A/D fields, N+1 P-CSI-RS resource set ID fields, and M+1 TCI state ID fields per P-CSI-RS resource set ID field. The N+1 A/D fields individually correspond to the N+1 P-CSI-RS resource set ID fields. A P-CSI-RS resource set indicated by one P-CSI-RS resource set ID field includes M+1 P-CSI-RS resources. The M+1 TCI state fields corresponding to one P-CSI-RS resource set individually correspond to the M+1 P-CSI-RS resources in the P-CSI-RS resource set. In a case where the value of the A/D field is 1, a P-CSI-RS resource set indicated by the corresponding P-CSI-RS resource set ID field may be activated, and corresponding M+1 TCI state fields may exist. In a case where the value of the A/D field is 0, a P-CSI-RS resource set indicated by the corresponding P-CSI-RS resource set ID field may be deactivated, and corresponding M+1 TCI state fields may not exist.

According to the third embodiment described above, the state of a P-CSI-RS can be changed without performing RRC reconfiguration, and a large number of P-CSI-RS resources can be efficiently used.

### Fourth Embodiment

The UE may support a scheme in which a TCI state of a P-CSI-RS is simultaneously updated across a plurality of CCs.

If a serving cell indicated by a MAC CE for a P-CSI-RS resource or a P-CSI-RS resource set is configured as part of a simultaneous TCI updating list, the MAC CE may be applied to all serving cells configured in the simultaneous TCI updating list. The MAC CE may be any one of the MAC CEs of the first to third embodiments. The indicated serving cell may be a serving cell indicated by a serving cell ID field in the MAC CE. The simultaneous TCI updating list may be a first simultaneous TCI updating list (for example, simultaneousTCI-UpdateList-r16) or a second simultaneous TCI updating list (for example, simultaneousTCI-UpdateListSecond-r16).

According to the fourth embodiment described above, the overhead of TCI state updating can be suppressed.

### Fifth Embodiment

A P-CSI-RS resource may be common to a plurality of UEs, or may be shared by a plurality of UEs.

If a MAC CE updates a TCI state of a P-CSI-RS resource for one UE (for example, a first embodiment), it is difficult for a plurality of UEs to share the same P-CSI-RS resource.

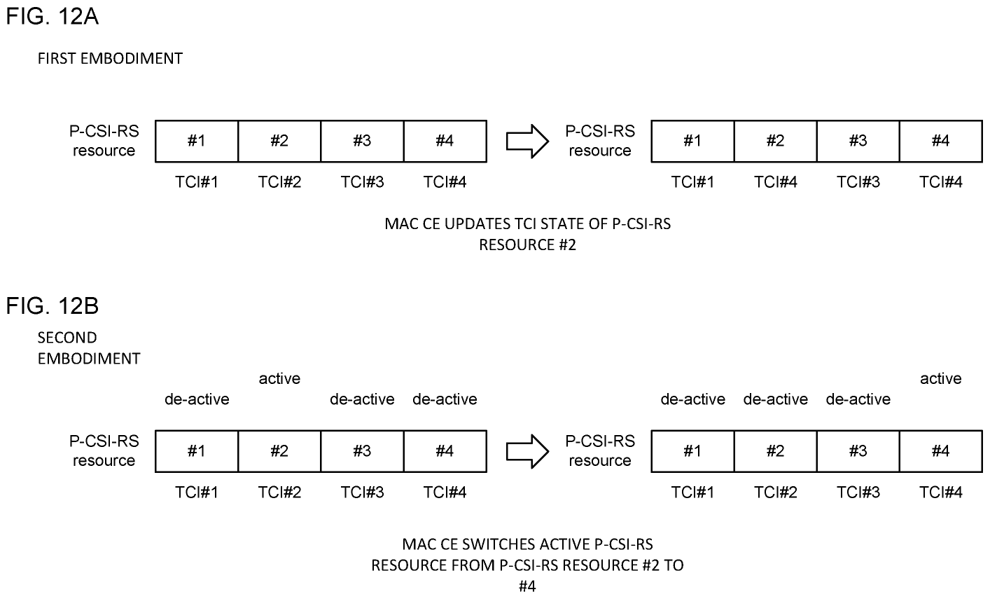

In the examples of FIGS. 12A and 12B, P-CSI-RSs #1 to #4 are configured. P-CSI-RSs #1 to #4 have TCIs #1 to #4, respectively.

In the example of FIG. 12A, the MAC CE updates the TCI state of P-CSI-RS #2 from TCI #2 to #4. If the TCI state of P-CSI-RS #2 is not simultaneously updated for all UEs, it is difficult for a plurality of UEs to share P-CSI-RS #2.

Group-common DCI (group-common signaling) using a new RNTI may be used. A specific field in the DCI may indicate at least one of updating of a TCI state of a P-CSI-RS resource and activation/deactivation of a P-CSI-RS resource. The DCI may schedule a PDSCH including a new MAC CE for at least one of updating of a TCI state of a P-CSI-RS resource and activation/deactivation of a P-CSI-RS resource. The new MAC CE may be any one of the MAC CEs of the first to fourth embodiments.

If a MAC CE activates/deactivates a P-CSI-RS resource (for example, a second embodiment), a plurality of UEs can share the same P-CSI-RS resource.

In the example of FIG. 12B, the active P-CSI-RS resource is P-CSI-RS #2. In this state, the MAC CE switches the active P-CSI-RS resource from P-CSI-RS #2 to #4. Since the TCI state of each P-CSI-RS resource does not change, a plurality of UEs can share the same P-CSI-RS resource. In a case where P-CSI-RS #2 is deactivated for one UE, whether P-CSI-RS #2 is actually transmitted to other UEs or not may depend on the implementation of the base station. An inactive P-CSI-RS may not be transmitted to all UEs.

Also a scheme in which an RRC parameter configures a plurality of P-CSI-RS resources, one TCI state/QCL assumption is mapped to one P-CSI-RS resource, and a MAC CE selects/indicates one P-CSI-RS resource is possible. The UE may assume a TCI state/QCL assumption corresponding to the selected/indicated P-CSI-RS resource.

A UE operation on an active CSI-RS resource and an inactive CSI-RS resource in the second embodiment and option 2 of the third embodiment will now be described.

The UE operation on an active CSI-RS resource may be similar to that of Rel. 15/16.

The UE may not need to measure an inactive P-CSI-RS resource in beam management/layer 1 (L1)-RSRP/beam failure recovery (BFR)/radio resource management (RLM).

A UE operation related to rate matching/puncturing of a PDSCH may conform to either one of options 1 and 2 below.

<<Option 1>>

An inactive CSI-RS resource may be used for a PDSCH. Rate matching/puncturing of a PDSCH may not be performed in (around) an inactive CSI-RS resource. Thereby, resource use efficiency can be enhanced.

<<Option 2>>

An inactive CSI-RS resource is not used for a PDSCH. Rate matching/puncturing of a PDSCH may be performed in (around) an inactive CSI-RS resource. Thereby, a plurality of UEs can share the inactive CSI-RS resource. A CSI-RS resource that is inactive to a UE may be active to another UE.

In simultaneous reception of an inactive CSI-RS and another DL signal (PDSCH/CSI-RS/TRS/SSB, or the like) using a different QCL type D, there may be no scheduling restriction caused by the inactive CSI-RS. Thereby, the base station can schedule a PDSCH using a different QCL type D in the same symbol as that of the inactive CSI-RS. The scheduling restriction caused by a specific signal (for example, a CSI-RS or an inactive CSI-RS) may be that, in the same symbol as that of the specific signal, the UE cannot receive another DL signal using a QCL type D different from the QCL type of the specific signal.

In Rel. 15, there is a scheduling restriction on a PDSCH using a different QCL type D on the same symbol as that of an SSB/CSI-RS.

In FR2, when a P-CSI-RS resource and a TCI state are configured by RRC, UE throughput is reduced in the same symbol as that of the P-CSI-RS resource due to the scheduling restriction/availability of a PDSCH having a QCL assumption different from the QCL assumption of the P-CSI-RS resource.

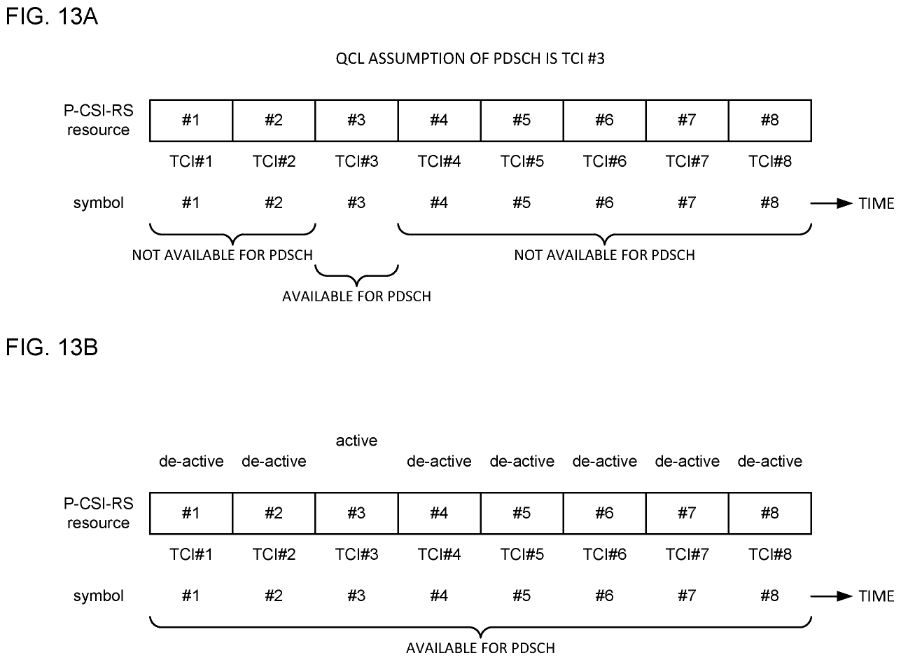

In the example of FIG. 13A, the TCI state of the PDSCH is TCI #3. The P-CSI-RS resources in symbols #1 to #8 have TCIs #1 to #8, respectively. In Rel. 15, only symbol #3 of the P-CSI-RS resource having the same TCI state is available for PDSCH, and symbols #1, #2, and #4 to #8 of the P-CSI-RS resource having different TCI states are not available for PDSCH. Thus, the number of symbols available for PDSCH is small.

In the example of FIG. 13B, the second embodiment is applied to the example of FIG. 13A. The P-CSI-RS resource of only symbol #3 is active, and the P-CSI-RS resources of symbols #1, #2, and #4 to #8 are inactive. Symbols #1 to #8 are available for PDSCH. That is, by using the second embodiment, a large number of symbols become available for PDSCH.

In a case where a P-CSI-RS resource is inactive, the UE may not need to measure the P-CSI-RS resource, and there may be no scheduling restriction. In other words, the UE may not need to receive an inactive CSI-RS resource, and there may be no scheduling restriction of a PDSCH on the same symbol as that of an inactive CSI-RS resource. On the other hand, in the same symbol as that of an active P-CSI-RS resource, there may be a scheduling restriction on a PDSCH having a different QCL type D.

Activation or deactivation of a P-CSI-RS resource may be applied to a P-CSI-RS resource having a specific use (for example, L1-RSRP/beam management/BFR). For a P-CSI-RS resource having a use other than the specific use, the UE may need to measure the P-CSI-RS resource. In the same symbol as that of a P-CSI-RS resource having a use other than the specific use, there may be a scheduling restriction on a PDSCH having a different QCL type D.

According to the fifth embodiment, a reduction in throughput due to scheduling restriction can be suppressed.

### Sixth Embodiment

A P-CSI-RS may be switched by a MAC CE. The MAC CE may be any one of the MAC CEs in the second embodiment. Note that, in the present disclosure, a P-CSI-RS and a P-TRS may be replaced with each other.

In a case where one of a plurality of P-CSI-RS resources is indicated/activated by a MAC CE, another P-CSI-RS resource may be deactivated. The UE may measure an active CSI-RS resource, and may not measure an inactive CSI-RS resource. The number of active CSI-RS resources may be one or fewer (or one). The UE may not assume that a plurality of CSI-RS resources are simultaneously activated.

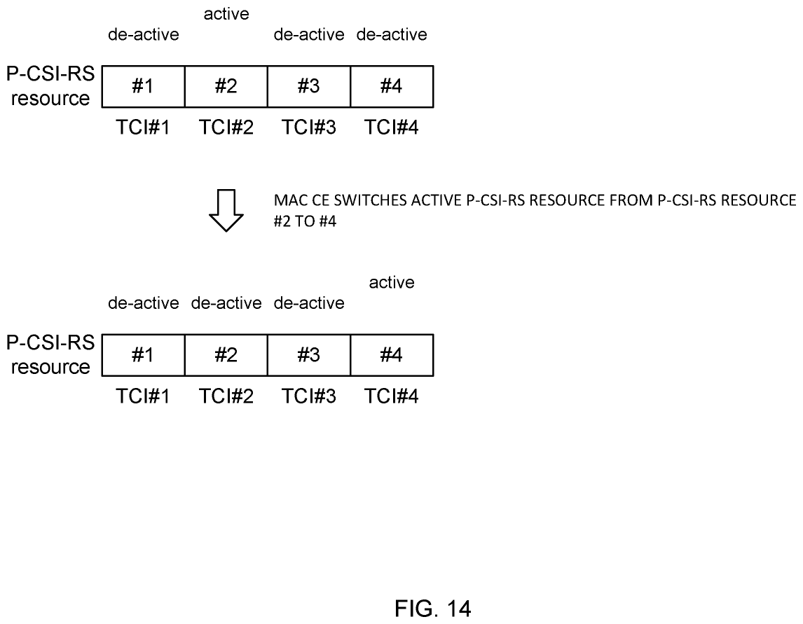

In the example of FIG. 14, P-CSI-RS resources #1 to #4 have TCI states #1 to #4, respectively. P-CSI-RS resource #2 is the only active P-CSI-RS resource before switching. In a case where P-CSI-RS resource #4 is activated by a MAC CE, P-CSI-RS resource #2 is deactivated. P-CSI-RS resource #4 is the only active P-CSI-RS resource after switching.

The timing at which a P-CSI-RS is switched (measured) may be 3 ms after the transmission of a HARQ-ACK for a PDSCH on which a MAC CE indicating the P-CSI-RS is mounted, or may be 3 ms+x after the transmission of the HARQ-ACK. Here, x may be referred to as an additional offset value. x may be prescribed in specifications, may be configured by higher layer signaling, or may be reported by UE capability.

According to the sixth embodiment described above, a P-CSI-RS resource can be appropriately switched.

### Seventh Embodiment

According to the sixth embodiment, only one P-CSI-RS resource is measured per UE. The measurement period may vary depending on a use such as radio resource management (RLM)/beam failure detection (BFD)/L1-RSRP/L1-SINR/CQI. Thus, among one or more P-CSI-RS resources in a list (group or use), only one P-CSI-RS resource may be activated.

A list of CSI-RS resources (CSI-RS resource IDs) may be configured by higher layer signaling. One of the CSI-RS resource IDs included in the list may be indicated by a MAC CE. A CSI-RS resource corresponding to, among the CSI-RS resource IDs included in the list, a CSI-RS resource ID other than the indicated CSI-RS resource ID may be deactivated (may not be measured).

For each UE, one list may be configured, or a plurality of lists may be configured. For each band, one list may be configured, or a plurality of lists may be configured. For each cell, one list may be configured, or a plurality of lists may be configured. For each DL BWP, one list may be configured, or a plurality of lists may be configured. For each use (for example, RLM/BFD/L1-RSRP/L1-SINR/CQI, or the like), one list may be configured, or a plurality of lists may be configured.

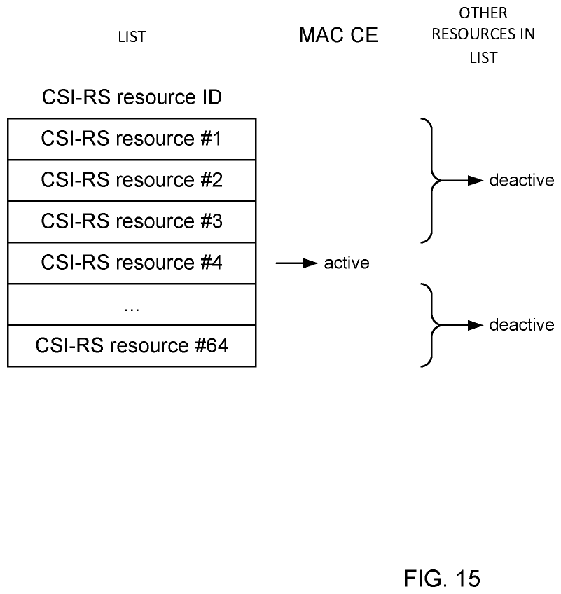

In the example of FIG. 15, a list including CSI-RS resource IDs #1 to #64 is configured. In a case where CSI-RS resource #4 is indicated (activated) by a MAC CE, the other CSI-RS resources in the list (#1 to #3, and #5 to #64) may be deactivated.

According to the seventh embodiment described above, the UE can appropriately measure one CSI-RS resource for each list.

### Eighth Embodiment

One or more common beams may be configured for a plurality of channels/RSs in UL/DL (or all channels and RSs in UL and DL). Some of the one or more common beams may be allocated (configured/indicated) to each channel. Thereby, the overhead of beam indication by a MAC CE/DCI for a dedicated channel can be suppressed.

A beam (TCI state or CSI-RS resource) in at least one of the first to seventh embodiments may be a common beam. A beam selected (indicated) by at least one of the first to seventh embodiments may be applied to a channel/RS (signal) in UL/DL. In a case where a CSI-RS resource is selected (indicated) by at least one of the first to seventh embodiments, the UE may update a beam (QCL assumption) of at least one specific channel/RS in UL/DL to a beam (QCL assumption) of the selected CSI-RS resource.

The specific channel/RS (channel/RS in DL/UL) may be at least one of a PDCCH, a PDSCH, a CSI-RS, a TRS, a PUCCH, a PUSCH, and a SRS.

The specific channel/RS may be a channel/RS configured by higher layer signaling. For example, it may be notified by RRC that a common beam is applied to a PDCCH and a PDSCH.

The specific channel/RS may be a channel/RS prescribed by specifications. For example, it may be prescribed in specifications that a common beam is applied to a PDCCH and a PDSCH.

In a case where it is intended that a QCL of a resource be configured in a common beam by higher layer signaling, a QCL of a CSI-RS resource selected by at least one of the first to seventh embodiments may be applied to the QCL of the resource mentioned above. In a case where it is intended that a QCL of a resource be configured in a beam other than a common beam by higher layer signaling, a configured QCL may be applied to the QCL of the resource mentioned above.

For example, in a case where the TCI state of CORESET #1 is configured in a common beam by higher layer signaling and a CSI-RS resource is selected by at least one of the first to seventh embodiments, the TCI state of CORESET #1 is updated to a beam (QCL assumption) of the selected CSI-RS resource. For example, in a case where the UL TCI state or the spatial relation of PUCCH resource #1 is configured in a common beam by higher layer signaling and a CSI-RS resource is selected by at least one of the first to seventh embodiments, the UL TCI state or the spatial relation of PUCCH resource #1 is updated to a beam (QCL assumption) of the selected CSI-RS resource.

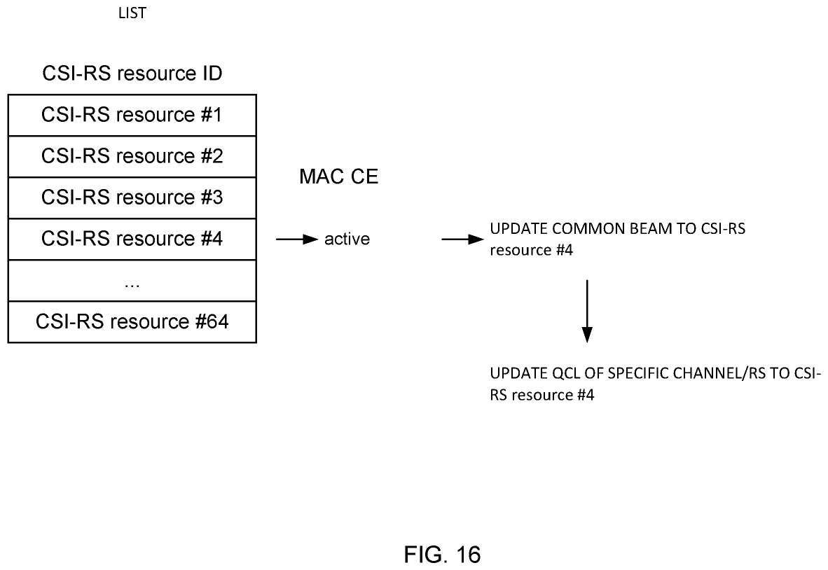

In the example of FIG. 16, a list including CSI-RS resource IDs #1 to #64 is configured. In a case where CSI-RS resource #4 is indicated (activated) by a MAC CE, the common beam is updated to the QCL of CSI-RS resource #4. Thereby, the QCL of at least one specific channel/RS is updated to the QCL of CSI-RS resource #4.

According to the eighth embodiment described above, the overhead of beam notification can be suppressed.

### Ninth Embodiment

An RRC parameter that enables any function of the first to eighth embodiments (for example, updating of a P-CSI-RS resource based on a MAC CE) may be configured in the UE. A UE configured with the RRC parameter may use the function, and a UE not configured with the RRC parameter may not use the function.

The UE may report UE capability information indicating that the UE supports any function of the first to eighth embodiments (for example, updating of a P-CSI-RS resource based on a MAC CE). In a case where the UE reports UE capability information indicating the support of the function, the UE may use the function. In a case where the UE reports UE capability information indicating the support of the function, the UE may be configured with an RRC parameter that enables the function. In a case where the UE reports UE capability information indicating the support of the function and is configured with an RRC parameter that enables the function, the UE may use the function.

The UE capability may indicate the number (maximum number) of configurable information elements. The information element may be at least one of a CSI-RS resource, a CSI-RS resource per list, and a list. The maximum number of lists may be the maximum number of lists per UE/per band/per cell/per DL BWP. A number of information elements equal to or fewer than the maximum number reported by UE capability may be configured.

According to the ninth embodiment described above, a large number of P-CSI-RS resources can be efficiently used while compatibility with existing specifications is kept.

(Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

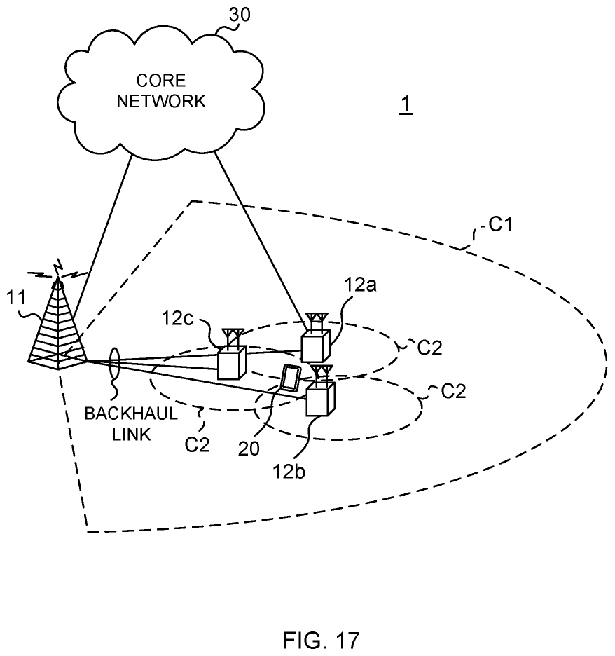

FIG. 17 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is the MN, and an LTE (E-UTRA) base station (eNB) is the SN.

The radio communication system 1 may support dual connectivity between a plurality of base stations in the same RAT (for example, dual connectivity in which both the MN and the SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a frequency range 1 (FR1) or a frequency range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency bands, definitions, and the like of the FR1 and FR2 are not limited thereto, and, for example, the FR1 may correspond to a frequency band higher than the FR2.

Further, the user terminal 20 may perform communication in each CC using at least one of time division duplex (TDD) or frequency division duplex (FDD).

The plurality of base stations 10 may be connected by wire (e.g., an optical fiber or an X2 interface in compliance with common public radio interface (CPRI)) or wirelessly (e.g., NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), or a next generation core (NGC).

The user terminal 20 may a terminal that corresponds to at least one of communication methods such as LTE, LTE-A, and 5G.

In the radio communication system 1, a radio access method based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH), a physical broadcast channel (PBCH), a physical downlink control channel (PDCCH), or the like shared by the user terminals 20 may be used.

Further, in the radio communication system 1, as an uplink channel, a physical uplink shared channel (PUSCH), a physical uplink control channel (PUCCH), a physical random access channel (PRACH), or the like shared by the user terminals 20 may be used.

User data, higher layer control information, a system information block (SIB), and the like are transmitted on the PDSCH. The PUSCH may transmit the user data, higher layer control information, and the like. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH or the PUSCH.

Note that the DCI that schedules the PDSCH may be referred to as DL assignment, DL DCI, or the like, and the DCI that schedules PUSCH may be referred to as UL grant, UL DCI, or the like. Note that the PDSCH may be replaced with DL data, and the PUSCH may be replaced with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. The UE may monitor the CORESET associated with a certain search space based on search space configuration.

One search space may correspond to a PDCCH candidate corresponding to one or more aggregation levels. One or more search spaces may be referred to as a search space set. Note that “search space” and “search space set”, “search space configuration” and “search space set configuration”, and “CORESET” and “CORESET configuration”, and the like in the present disclosure may be replaced with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), or scheduling request (SR) may be transmitted on the PUCCH. A random access preamble for establishing connection with a cell may be transmitted on the PRACH.

Note that in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). Note that, DMRSs may be referred to as “user terminal-specific reference signals (UE-specific Reference Signals).”

(Base Station)

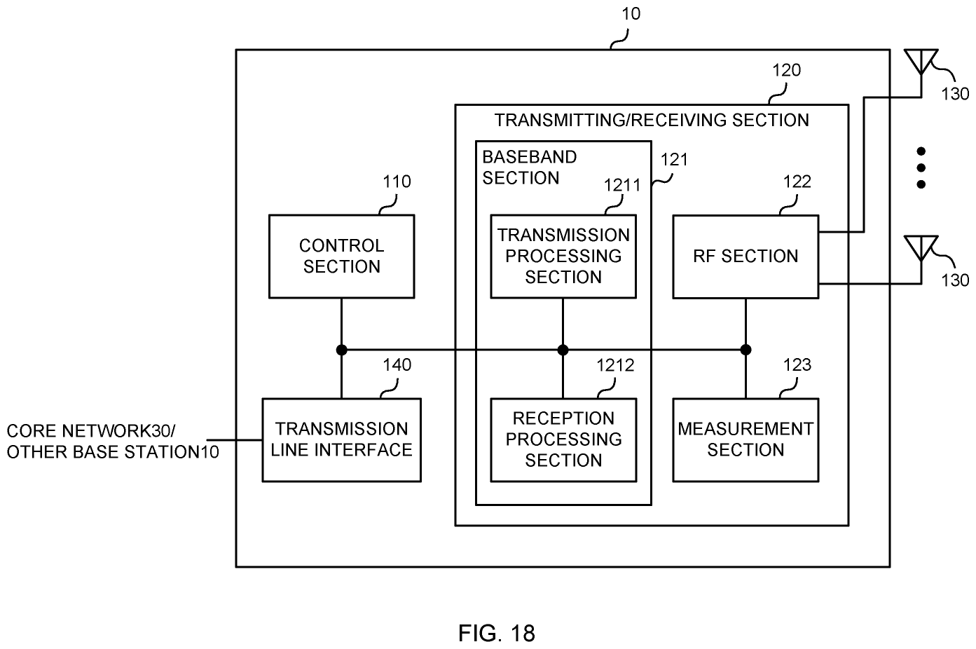

FIG. 18 is a diagram illustrating an example of a configuration of the base station according to one embodiment. The base station 10 includes a control section 110, a transmitting/receiving section 120, a transmission/reception antenna 130, and a transmission line interface 140. Note that one or more control sections 110, one or more transmitting/receiving sections 120, one or more transmission/reception antennas 130, and one or more transmission line interfaces 140 may be included.

Note that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be implemented by a controller, a control circuit, and the like that are described based on common recognition in the technical field related to the present disclosure.

The control section 110 may control signal generation, scheduling (for example, resource allocation or mapping), and the like. The control section 110 may control transmission/reception, measurement, and the like using the transmitting/receiving section 120, the transmission/reception antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmitting/receiving section 120 may be configured as an integrated transmitting/receiving section, or may be configured by a transmitting section and a receiving section. The transmitting section may include the transmission processing section 1211 and the RF section 122. The receiving section may be implemented by the reception processing section 1212, the RF section 122, and the measurement section 123.

The transmission/reception antennas 130 can be implemented by antennas described based on common recognition in the technical field related to the present disclosure, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam or a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correcting encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency band, filtering processing, amplification, and the like on the baseband signal, and may transmit a signal in the radio frequency band via the transmission/reception antenna 130.

Meanwhile, the transmitting/receiving section 120 (RF section 122) may perform amplification, filtering processing, demodulation to a baseband signal, and the like on the signal in the radio frequency band received by the transmission/reception antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, another base stations 10, and the like, and may acquire, transmit, and the like user data (user plane data), control plane data, and the like for the user terminal 20.

Note that the transmitting section and the receiving section of the base station 10 in the present disclosure may include at least one of the transmitting/receiving section 120, the transmission/reception antenna 130, or the transmission line interface 140.

The transmitting/receiving section 120 may transmit one or more information elements for a configuration of a periodic channel state information-reference signal (CSI-RS). The control section 110 may control the transmission of a medium access control-control element (MAC CE) including one or more transmission control indication (TCI) states. The one or more TCI states may individually correspond to the one or more information elements, and each of the one or more information elements may indicate either one of a CSI-RS resource and a CSI-RS resource set.

The transmitting/receiving section 120 may transmit one or more information elements for a configuration of a periodic channel state information-reference signal (CSI-RS). The control section 110 may control the transmission of a medium access control-control element (MAC CE) including one or more bits. The one or more bits may individually correspond to the one or more information elements, each of the one or more bits may indicate activation or deactivation of the corresponding information element, and each of the one or more information elements may indicate either one of a CSI-RS resource and a CSI-RS resource set.

The transmitting/receiving section 120 may transmit a configurations of a plurality of channel state information-reference signal (CSI-RS) resources. The control section 110 may control the transmission of a medium access control-control element (MAC CE) indicating one CSI-RS resource among the plurality of CSI-RS resources. Measurement of the CSI-RS resource may be performed. Measurement of a CSI-RS resource other than the CSI-RS resource among the plurality of CSI-RS resources may not be performed. The plurality of CSI-RS resources may be individually associated with a plurality of quasi co-locations (QCLs).

(User Terminal)

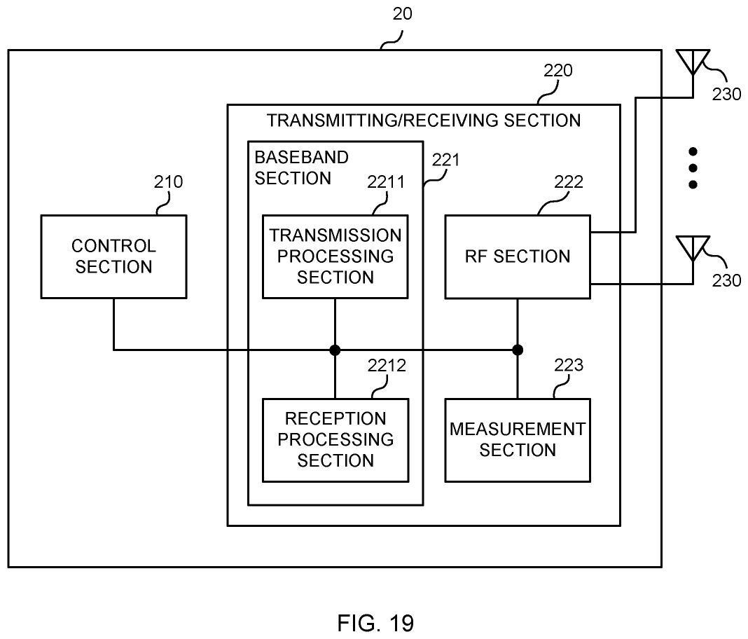

FIG. 19 is a diagram illustrating an example of a configuration of the user terminal according to one embodiment. The user terminal 20 includes a control section 210, a transmitting/receiving section 220, and a transmission/reception antenna 230. Note that one or more of the control sections 210, one or more of the transmitting/receiving sections 220, and one or more of the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described on the basis of common recognition in the technical field related to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data, control information, a sequence, and the like to be transmitted as signals, and may forward the data, control information, sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be implemented by a transmitter/receiver, an RF circuit, a baseband circuit, a filter, a phase shifter, a measurement circuit, a transmission/reception circuit, and the like that are described based on common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may include the reception processing section 2212, the RF section 222, and the measurement section 223.

The transmission/reception antenna 230 can include an antenna described on the basis of common recognition in the technical field related to the present disclosure, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam or a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmitting/receiving section 220 (transmission processing section 2211) may perform transmission processing such as channel encoding (which may include error correcting encoding), modulation, mapping, filtering processing, DFT processing (if necessary), IFFT processing, precoding, or digital-analog conversion on the bit string to be transmitted, to output a baseband signal.

Note that whether or not to apply DFT processing may be determined based on configuration of transform precoding. In a case where transform precoding is enabled for a certain channel (e.g., PUSCH), the transmitting/receiving section 220 (transmission processing section 2211) may perform DFT processing as the transmission processing in order to transmit the channel using a DFT-s-OFDM waveform. In a case where it is not the case, DFT processing need not be performed as the transmission processing.

The transmitting/receiving section 220 (RF section 222) may perform modulation to a radio frequency range, filtering processing, amplification, and the like on the baseband signal, to transmit a signal in the radio frequency range via the transmission/reception antenna 230.

Meanwhile, the transmitting/receiving section 220 (RF section 222) may perform amplification, filtering processing, demodulation to a baseband signal, and the like on the signal in the radio frequency range received by the transmission/reception antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may include at least one of the transmitting/receiving section 220, the transmission/reception antenna 230, or the transmission line interface 240.

The transmitting/receiving section 220 may receive one or more information elements for a configuration of a periodic channel state information-reference signal (CSI-RS). The control section 210 may control the reception of a medium access control-control element (MAC CE) including one or more transmission control indication (TCI) states. The one or more TCI states may individually correspond to the one or more information elements, and each of the one or more information elements may indicate either one of a CSI-RS resource and a CSI-RS resource set.

The MAC CE may include the one or more IDs, and the one or more IDs may individually indicate the one or more information elements.

The MAC CE may include the one or more bits, the one or more bits may individually correspond to the one or more information elements, and each of the one or more bits may indicate activation or deactivation of the corresponding information element.

The transmitting/receiving section 220 may receive a list indicating a plurality of serving cells, the MAC CE may indicate a serving cell, and in a case where the serving cell is included in the list, the control section may apply the MAC CE to the plurality of serving cells.

The transmitting/receiving section 220 may receive one or more information elements for a configuration of a periodic channel state information-reference signal (CSI-RS). The control section 210 may control the reception of a medium access control-control element (MAC CE) including one or more bits. The one or more bits may individually correspond to the one or more information elements, each of the one or more bits may indicate activation or deactivation of the corresponding information element, and each of the one or more information elements may indicate either one of a CSI-RS resource and a CSI-RS resource set.

The MAC CE may include the one or more IDs, and the one or more IDs may individually indicate the one or more information elements.

In a case where one information element among the one or more information elements is inactive, scheduling of a physical downlink shared channel having a different quasi co-location (QCL) type D may not be restricted in a symbol corresponding to the information element.

The MAC CE may include the one or more TCI states, and the one or more TCI states may individually correspond to the one or more information elements.

The transmitting/receiving section 220 may receive a configuration of a plurality of channel state information-reference signal (CSI-RS) resources, and may receive a medium access control-control element (MAC CE) indicating one CSI-RS resource among the plurality of CSI-RS resources. The control section 210 may perform measurement of the CSI-RS resource, and may not perform measurement of a CSI-RS resource other than the CSI-RS resource among the plurality of CSI-RS resources. The plurality of CSI-RS resources may be individually associated with a plurality of quasi co-locations (QCLs).

Each of the plurality of CSI-RS resources may be a periodic CSI-RS resource.

The configuration may include a list of the plurality of CSI-RS resources.

The control section may apply a QCL associated with the CSI-RS resource to at least one signal (specific channel/RS).

(Hardware Configuration)

Note that the block diagrams that have been used to describe the above embodiments illustrate blocks in functional units. These functional blocks (components) may be implemented in arbitrary combinations of at least one of hardware or software. Further, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional block may be realized by combining the one apparatus or the plurality of apparatuses with software.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited.

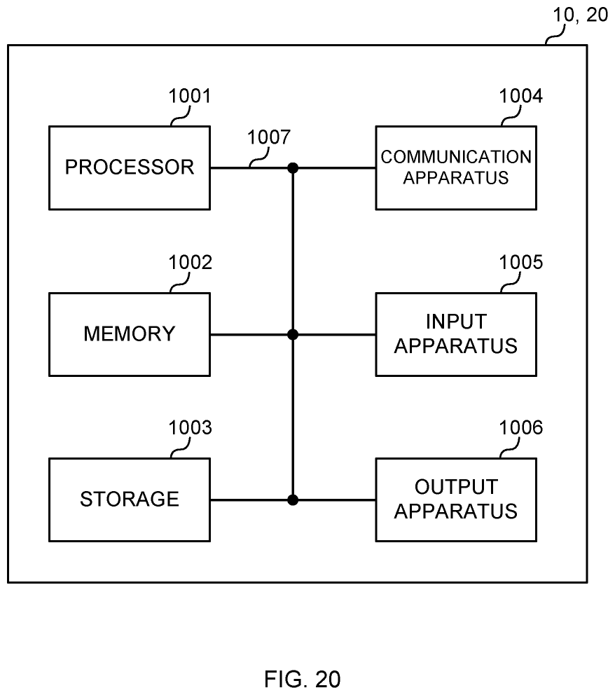

For example, the base station, the user terminal, and the like according to one embodiment of the present disclosure may function as a computer that executes the processing of the radio communication method of the present disclosure. FIG. 20 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, or a unit can be replaced with each other. The hardware configuration of the base station 10 and the user terminal 20 may be designed to include one or more of the apparatuses illustrated in the drawings, or may be designed not to include some apparatuses.

For example, although only one processor 1001 is shown, a plurality of processors may be provided. Further, the processing may be executed by one processor, or the processing may be executed by two or more processors simultaneously or sequentially, or using other methods. Note that the processor 1001 may be implemented with one or more chips.

Each function of the base station 10 and the user terminal 20 is implemented by predetermined software (program) being read on hardware such as the processor 1001 and the memory 1002, by which the processor 1001 performs operations, controlling communication via the communication apparatus 1004, and controlling at least one of reading or writing of data at the memory 1002 and the storage 1003.

The processor 1001 may control the whole computer by, for example, running an operating system. The processor 1001 may be implemented by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

The processor 1001 reads programs (program codes), software modules, data, etc. from at least one of the storage 1003 or the communication apparatus 1004 into the memory 1002, and performs various types of processing according to these. As the program, a program that causes a computer to execute at least a part of the operation described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store programs (program codes), software modules, etc. that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus.”

The communication apparatus 1004 is hardware (transmission/reception device) for performing inter-computer communication via at least one of a wired network or a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmitting/receiving section 120 (220), the transmission/reception antenna 130 (230), and the like described above may be implemented by the communication apparatus 1004. The transmitting/receiving section 120 (220) may be implemented by being physically or logically separated into the transmitting section 120a (220a) and the receiving section 120b (220b).

The input apparatus 1005 is an input device for receiving input from the outside (for example, a keyboard, a mouse, a microphone, a switch, a button, a sensor and so on). The output apparatus 1006 is an output device that performs output to the outside (for example, a display, a speaker, a light emitting diode (LED) lamp, or the like). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented with at least one of these pieces of hardware.

(Modification)

Note that terms described in the present disclosure and terms necessary for understanding the present disclosure may be replaced with terms that have the same or similar meanings. For example, a channel, a symbol, and a signal (signal or signaling) may be replaced with each other. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may be comprised of one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, or specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, a slot may be a time unit based on numerology.

The slot may include a plurality of mini slots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. A PDSCH (or a PUSCH) transmitted using a mini slot may be referred to as PDSCH (PUSCH) mapping type B.

A radio frame, a subframe, a slot, a mini slot and a symbol all represent the time unit in signal communication. The radio frame, the subframe, the slot, the mini slot, and the symbol may be called by other applicable names, respectively. Note that time units such as a frame, a subframe, a slot, a mini slot, and a symbol in the present disclosure may be replaced with each other.

For example, one subframe may be referred to as TTI, a plurality of consecutive subframes may be referred to as TTI, or one slot or one mini slot may be referred to as TTI. That is, at least one of the subframe or the TTI may be a subframe (1 ms) in the existing LTE, may be a period shorter than 1 ms (for example, one to thirteen symbols), or may be a period longer than 1 ms. Note that the unit to represent the TTI may be referred to as a “slot,” a “mini slot” and so on, instead of a “subframe.”

Here, a TTI refers to the minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTIs is not limited to this.

The TTI may be a transmission time unit of a channel-coded data packet (transport block), a code block, a codeword, etc. or may be a processing unit of scheduling, link adaptation, etc. When the TTI is given, a time interval (e.g., the number of symbols) to which a transport block, a code block, a codeword, or the like is actually mapped may be shorter than the TTI.

Note that, when one slot or one mini slot is referred to as a “TTI,” one or more TTIs (that is, one or multiple slots or one or more mini slots) may be the minimum time unit of scheduling. Also, the number of slots (the number of mini slots) to constitute this minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

Note that a long TTI (for example, a normal TTI, a subframe, etc.) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in an RB may be determined based on a numerology.

Also, an RB may include one or more symbols in the time domain, and may be one slot, one mini slot, one subframe or one TTI in length. One TTI, one subframe, etc. may each be comprised of one or more resource blocks.

Note that one or more RBs may be referred to as a physical resource block (PRB), a sub-carrier group (SCG), a resource element group (REG), a PRB pair, an RB pair, and the like.

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE does not have to expect transmission/reception of a predetermined signal/channel outside the active BWP. Note that “cell”, “carrier”, etc. in the present disclosure may be replaced with “BWP”.

Note that the structures of radio frames, subframes, slots, mini slots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, etc. described in the present disclosure may be represented using absolute values, or may be represented using relative values with respect to predetermined values, or may be represented using other corresponding information. For example, a radio resource may be specified by a predetermined index.

The names used for parameters etc. in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, etc. described in the present disclosure may be represented using any of a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Information, signals, etc. can be output in at least one of a direction from a higher layer to a lower layer or a direction from a lower layer to a higher layer. Information, signals and so on may be input and output via a plurality of network nodes.

The information, signals and so on that are input and/or output may be stored in a specific location (for example, in a memory), or may be managed in a control table. The information, signals, and the like to be input and output can be overwritten, updated, or appended. The output information, signals, and the like may be deleted. The information, signals and so on that are input may be transmitted to other pieces of apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of the MAC signaling may be performed using, for example, an MAC control element (CE).

Also, reporting of predetermined information (for example, reporting of information to the effect that “X holds”) does not necessarily have to be sent explicitly, and can be sent implicitly (for example, by not reporting this piece of information, by reporting another piece of information, and so on).

Decisions may be made in values represented by one bit (0 or 1), may be made in Boolean values that represent true or false, or may be made by comparing numerical values (for example, comparison against a predetermined value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server, or another remote source by using at least one of a wired technology (coaxial cable, optical fiber cable, twisted pair, digital subscriber line (DSL), or the like) or a wireless technology (infrared rays, microwaves, and the like), at least one of the wired technology or the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” can be used interchangeably.

The mobile station may be referred to as a subscriber station, mobile unit, subscriber station, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station or the mobile station may be called as a transmitting apparatus, a receiving apparatus, a wireless communication apparatus, and the like. Note that at least one of the base station or the mobile station may be a device mounted on a moving object, a moving object itself, and the like. The moving object may be a transportation (for example, a car, an airplane, or the like), an unmanned moving object (for example, a drone, an autonomous car, or the like), or a (manned or unmanned) robot. Note that at least one of the base station or the mobile station also includes an apparatus that does not necessarily move during a communication operation. For example, at least one of the base station or the mobile station may be an Internet of Things (IoT) device such as a sensor.

Further, the base station in the present disclosure may be replaced with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be replaced with terms corresponding to communication between terminals (for example, “side”). For example, an uplink channel, a downlink channel, etc. may be replaced with a side channel.

Likewise, a user terminal in the present disclosure may be replaced with a base station. In this case, the base station 10 may have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, the methods described in the present disclosure have presented various step elements using an exemplary order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded on the basis of these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on.”

All references to the elements using designations such as “first” and “second” as used in the present disclosure do not generally limit the amount or sequence of these elements. These designations can be used in the present disclosure, as a convenient way of distinguishing between two or more elements. In this way, reference to the first and second elements does not imply that only two elements may be employed, or that the first element must precede the second element in some way.

The term “determining” as used in the present disclosure may include a wide variety of operations. For example, “determining” may be regarded as “determining” judging, calculating, computing, processing, deriving, investigating, looking up (or searching or inquiring) (for example, looking up in a table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

In addition, “determining” may be replaced with “assuming”, “expecting”, “considering”, or the like.

The “maximum transmission power” described in the present disclosure may mean a maximum value of transmission power, nominal UE maximum transmit power, or rated UE maximum transmit power.

The terms “connected” and “coupled” used in the present disclosure, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access”.

In the present disclosure, when two elements are connected together, it is conceivable that the two elements are “connected” or “coupled” to each other by using one or more electrical wires, cables, printed electrical connections, and the like, and, as some non-limiting and non-inclusive examples, by using electromagnetic energy having wavelengths in the radio frequency domain, microwave region, or optical (both visible and invisible) region, or the like.

In the present disclosure, the terms “A and B are different” may mean “A and B are different from each other”. Note that the phrase may mean that “A and B are different from C”. The terms such as “separate”, “coupled”, and the like may be interpreted similarly to “different”.

When “include”, “including”, and variations of these are used in the present disclosure, these terms are intended to be inclusive similarly to the term “comprising”. Moreover, the term “or” used in the present disclosure is intended to be not an exclusive-OR.

In the present disclosure, when articles are added by translation, for example, as “a”, “an”, and “the” in English, the present disclosure may include that nouns that follow these articles are plural.

In the above, the invention according to the present disclosure has been described in detail; however, it is obvious to those skilled in the art that the invention according to the present disclosure is not limited to the embodiments described in the present disclosure. The invention according to the present disclosure can be embodied with various corrections and in various modified aspects, without departing from the spirit and scope of the invention defined on the basis of the description of claims. Consequently, the description of the present disclosure is provided only for the purpose of explaining examples, and should by no means be construed to limit the invention according to the present disclosure in any way.

1.-9. (canceled)

10. A terminal comprising:
a receiver that receives a medium access control-control element (MAC CE) activating a channel state information-reference signal (CSI-RS) resource among multiple CSI-RS resources configured by higher layer signaling; and
a processor that applies, to multiple signals, quasi co-location (QCL) associated with the CSI-RS resource.

11. The terminal according to claim 10, wherein the processor applies the QCL associated with the CSI-RS resource to a physical downlink shared channel (PDSCH), a physical downlink control channel (PDCCH), a CSI-RS, a physical uplink shared channel (PUSCH), a physical uplink control channel (PUCCH), and a sounding reference signal (SRS).

12. A radio communication method for a terminal, comprising:
receiving a medium access control-control element (MAC CE) activating a channel state information-reference signal (CSI-RS) resource among multiple CSI-RS resources configured by higher layer signaling; and
applying, to multiple signals, quasi co-location (QCL) associated with the CSI-RS resource.

13. A base station comprising:
a transmitter that transmits a medium access control-control element (MAC CE) activating a channel state information-reference signal (CSI-RS) resource among multiple CSI-RS resources configured by higher layer signaling; and
a processor that applies, to multiple signals, quasi co-location (QCL) associated with the CSI-RS resource.

14. A system comprising a terminal and a base station, wherein
the terminal comprises:
a receiver that receives a medium access control-control element (MAC CE) activating a channel state information-reference signal (CSI-RS) resource among multiple CSI-RS resources configured by higher layer signaling; and
a processor that applies, to multiple signals, quasi co-location (QCL) associated with the CSI-RS resource, and
the base station comprises:
a transmitter that transmits the MAC CE.
